(19) United States
(12) Patent Application Publication
(10) Pub. No.: US 2026/0054607 A1
(43) Pub. Date: Feb. 26, 2026

(54) TWO-PART VEHICLE SEAT

(71) Applicant: FLEXIS, BOULOGNE-BILLANCOURT (FR)

(72) Inventors: Pierre CHEREAU, GUYANCOURT (FR); Vincent DUCHENE AKKODIS, GUYANCOURT (FR); Philippe LAPORTE-GALAA, GUYANCOURT CEDEX (FR)

(21) Appl. No.: 19/304,388

(22) Filed: Aug. 19, 2025

(30) Foreign Application Priority Data
Aug. 20, 2024 (FR) FR2409007

(51) Int. Cl. B60N 2/015; B60N 2/08

(52) U.S. Cl. CPC B60N 2/01583; B60N 2/08

(57) ABSTRACT

A vehicle seat including: a chair that includes a seat and a backrest, and a support able to be mounted on a floor of the motor vehicle and on which the chair is mounted. The support includes an anchoring means, and the chair includes a first locking means able to lock onto said anchoring means to block the chair to the support, and a first manually maneuverable maneuvering means able to deactivate the first locking means to release the chair from the support.

### INCORPORATION BY REFERENCE TO ANY PRIORITY APPLICATIONS

Any and all applications for which a foreign or domestic priority claim is identified in the Application Data Sheet as filed with the present application are hereby incorporated by reference.

### FIELD

The present disclosure generally relates to the interior arrangements of motor vehicles.

It more particularly concerns a vehicle seat including a chair that comprises a seat and a backrest, and a support which is able to be mounted on a vehicle floor and on which the chair is mounted. It also relates to a motor vehicle equipped with such a seat.

### BACKGROUND

It is known to integrate rails into the floors of motor vehicles, notably of the minivan type.

These rails allow the seats to be mounted in the motor vehicle in such a way that they can slide back and forth along the floor, thus offering various positions. The rails are then equipped with locking mechanisms to ensure the seats are fixed in position during transport.

As explained in document FR2728860, the seats themselves can be modular, allowing them to be placed in different positions (facing the road or back to the road), or even removed to free up the floor for loading bulky objects into the motor vehicle.

However, these functions increase the complexity of the seats, as well as their weight.

Therefore, the high weight of the seats, which can reach 30 kilograms, makes them difficult to handle, especially when reconfiguring the interior of the vehicle space by extracting the seats from the rails to turn them around or remove them from the vehicle.

### SUMMARY

In order to remedy the aforementioned drawback of the state of the art, the present disclosure proposes to split the seat into two parts.

More particularly, according to the present disclosure, such a seat as defined in the introduction is proposed (with a support and a chair), in which:
one from the support and the chair includes anchoring means, and
the other from the support and the chair includes first locking means able to lock onto said anchoring means to block the chair on the support, and first maneuvering means (preferably manually maneuverable) and able to deactivate the first locking means to release the chair from the support.

The seat comprises a supporting structure on which the seat and backrest are mounted, and which includes either the first locking means and the first maneuvering means, or the anchoring means;

Thus, by means of the present disclosure, the chair and the support can be handled independently of each other.

The support indeed includes the part that allows the seat to be mounted on the floor, and which is relatively heavy (generally between 10 and 15 kg), while the chair includes only the structure that accommodates the passenger (and weighs between 15 and 20 kg).

With both parts weighing less than 20 kg each, they are easier to handle.

Another advantage provided by the present disclosure is that the support allows to not only accommodate the chair, but it can also receive other elements in place of the chair, for example, a system for fixing a bike or a board, or more generally any other equipment.

Other advantageous and non-limiting features of the seat in accordance with the present disclosure, taken individually or in any technically possible combination, are as follows:
the support includes the anchoring means, and the chair includes the first locking means and the first maneuvering means;
the support includes second locking means able to lock the support to the floor, and manually maneuverable second maneuvering means able to deactivate the second locking means to release at least one mobility of the support relative to the floor;
the floor integrating parallel rails, the second maneuvering means are able to release a sliding mobility of the support in said rails;
the anchoring means includes, at least three anchoring points, a rod on which the first locking means can be locked;
the first locking means includes, on the one hand, a fixed base defining a notch, and, on the other hand, a bolt mounted movable relative to the fixed base between an activated position in which it is able to block a rod at the bottom of the notch and a deactivated position in which it releases the rod;
four rods are provided, and the first locking means includes two latches and two locks able to be locked respectively on the four rods;
the chair is able to be mounted on the support with two distinct orientations;
the support includes fixing means able to block equipment distinct from the motor vehicle, preferably leisure and/or sports equipment such as a bike or a surfboard.

The present disclosure also proposes a motor vehicle including a chassis that comprises a floor, and at least one seat as mentioned above mounted on the floor.

Of course, the various features, alternatives, and embodiments of the present disclosure can be combined with each other according to various combinations as long as they are not incompatible or exclusive of each other.

### BRIEF DESCRIPTION OF THE DRAWINGS

The following description with reference to the appended drawings, given as non-limiting examples, will make it well understood what the present disclosure consists of and how it can be implemented.

In the appended drawings:

FIG. 1 is a schematic perspective view of the interior of a motor vehicle cabin, comprising a seat in accordance with the present disclosure, illustrated in the position of use;

FIG. 2 is a view similar to that of FIG. 1, in which the chair of the seat is partially removed from its support;

FIG. 3 is a schematic perspective view of the seat support of FIG. 1;

FIG. 4 illustrates a schematic perspective view of a lower part of the chair of the seat of FIG. 1 and two detailed views of this chair;

FIG. 5 is a view similar to that of FIG. 1, in which the chair of the seat is turned around;

FIG. 6 is a view similar to that of FIG. 1, in which the chair of the seat has been removed and is replaced by a bike.

### DETAILED DESCRIPTION

A motor vehicle 1 (car, bus, truck, boat, plane . . .) generally includes a chassis 10 comprising a floor 12 and body elements 11 that together define a cabin.

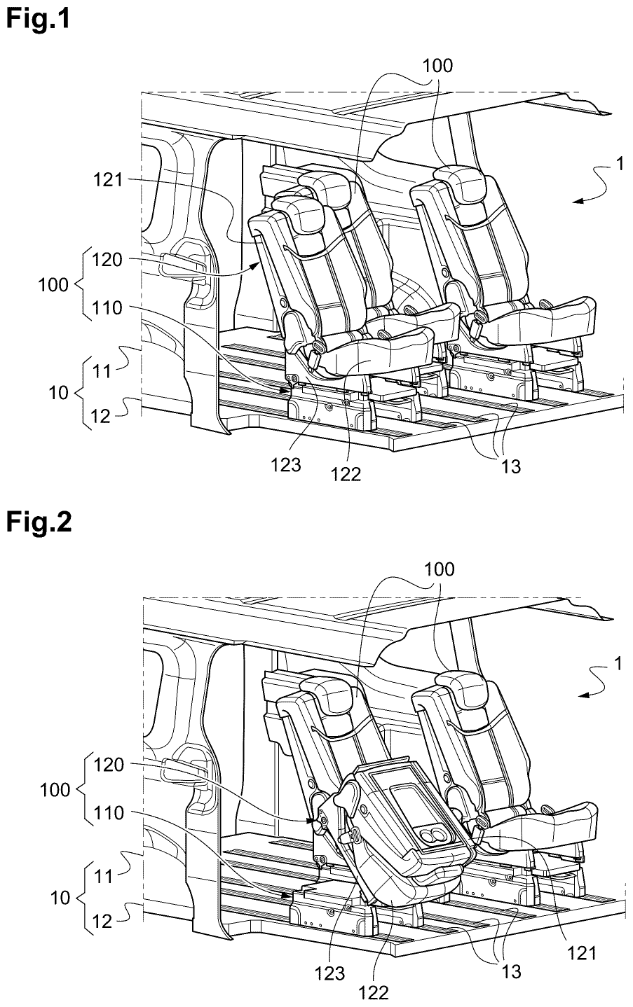

In FIG. 1, such a motor vehicle 1 is represented. It is a car, more specifically a minivan type vehicle (in other words, a car characterized by a monocoque body that integrates a cabin, an engine compartment, and a loading space without visible demarcation, thus creating a uniform and fluid silhouette). This vehicle includes at least one seat 100 provided to be installed in the cabin and fixed on the floor 12 of this motor vehicle.

In practice, such a motor vehicle includes several rows of seats, of which, at least one front row of at least two seats, and a rear row of at least two seats. Here, the rear row includes three identical seats, only one of which will be described. Of course, the vehicle may also accommodate other rows of seats. It could, for example, include three rows of two or three seats.

In the following description, the terms “front” and “rear” will be used relative to the motor vehicle 1, the front part of an element designating the part of this element located on the side of the vehicle hood and the rear part designating the part of this element located on the opposite side.

The terms “lower” (or “bottom”) and “upper” (or “top”) will be used in the same way, the lower part of an element designating the part of this element located on the side of the vehicle floor 12 and the upper part designating the part of this element located on the side of the vehicle roof.

The adjective “longitudinal” will apply to a direction or axis oriented from the front toward the rear of the vehicle, parallel to the forward direction of the vehicle when the steering wheel is in the neutral position.

The adjective “transversal” will apply to a direction or axis oriented orthogonally to the longitudinal axes and horizontally when the vehicle is driving on a horizontal road.

The term “fixed” (or “locked”) will be used to designate an assembly without any mobility between two elements.

Conversely, the term “mounted” will be used to designate an assembly with or without mobility between two elements.

As shown in FIG. 1, the seat 100 traditionally includes a chair 120 that comprises a seat 122 and a backrest 121 equipped with a headrest. These seat and backrest each comprise a frame and padding attached to the frame.

The backrest could be mounted on the seat, either fixedly or with tilting mobility to allow adjustment of its inclination.

Here, the backrest 121 and the seat 122 are mounted on a common supporting structure 123. This supporting structure 123 includes two flanks that extend longitudinally and in height, parallel to each other. The backrest 121 is mounted on these two flanks in such a way that it can be fully folded against the seat 121, which will facilitate handling of the chair 120.

Of course, as an alternative, the chair could present different forms. It could notably delimit not just one place, as represented, but several places to form a bench. However, this alternative is not preferred given the weight such a bench would present.

According to the present disclosure, the seat 100 includes, in addition to this chair 120, a support 110 that is able to be mounted on the vehicle floor 12 and on which the chair 120 is mounted. In other words, the seat 100 is formed of two removable parts relative to each other.

This support 110 includes for this purpose anchoring means 114 for the chair 120 and mounting means on the floor 12.

As for the chair 120, it includes corresponding first locking means 129 able to lock onto these anchoring means 114, as well as first manual maneuvering means 134, 144 (operable without tools) able to deactivate the first locking means 129 to release the chair 120 from the support 110. Thus, the chair 120 can be easily detached from its support 110.

These anchoring means 114, locking means 129, and maneuvering means 134, 144 could present very diverse forms.

Preferably, their form will be such that it will be possible to mount the chair 120 on the support 110 in a normal position (facing the road) or in a reversed position (back to the road).

Here, the particular embodiment of the seat 100 illustrated in the Figures can be presented, starting by describing the support 110.

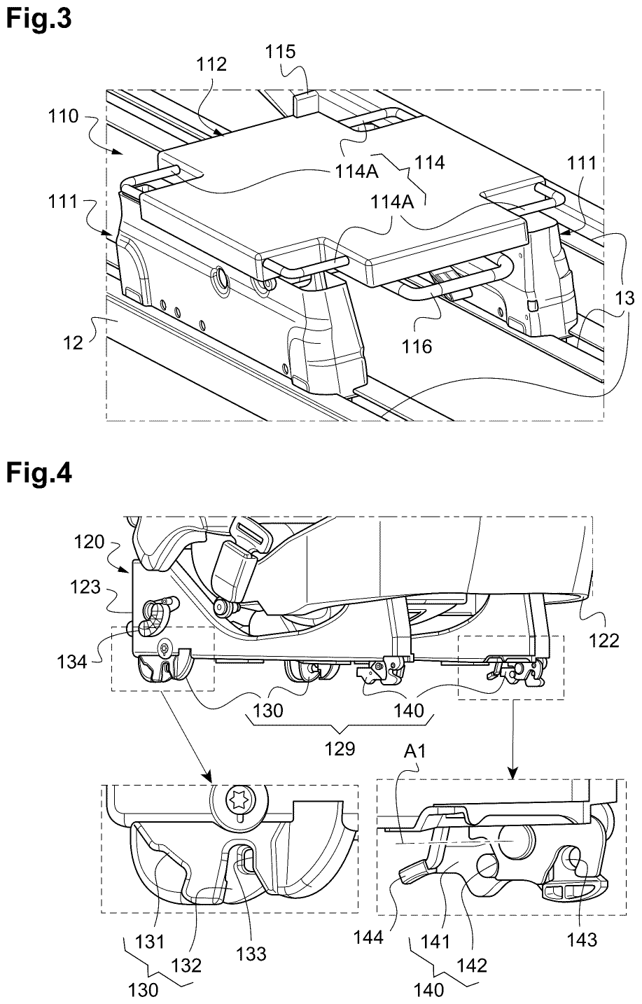

As shown in FIG. 3, this support 110 is provided to be mounted on the floor 12 of the motor vehicle 1.

It could be provided that it is fixed there. In this case, it would preferably be fixed removably, for example by means of bolts.

But preferably, the support 110 is mounted on the floor 12 to be longitudinally mobile and removable.

For this purpose, the floor 12 integrates parallel rails 13. Here, these rails are formed by rectangular section profiles, open on top, and preferably metallic. Two parallel rails 13 are preferably provided for each seat in the rear row. In the illustrated example, three pairs of rails are provided. Carpet is installed between the rails for comfort. Each rail internally includes notches.

The support 110 illustrated in FIG. 3 then includes a platform 112 here presenting in the form of a flat plate, and two feet 111 fixed under the platform, parallel to each other. These two feet are fixed to each other at least by this platform 112. However, to give them better rigidity, one or two additional crossbars can be used to connect the two feet 111 together.

These two feet 111 each include in the lower part a rib able to slide inside one of the rails 13, second locking means able to lock the support 110 in the rails 13 in a fixed position, and second manual maneuvering means (operable without tools) able to deactivate the second locking means to release the sliding mobility of the support 110 along the rails 13. These second maneuvering means are preferably also provided to allow the feet 111 to be extracted from the rails 13.

In the example represented in the Figures, the two feet 111 each present an elongated parallelepiped form longitudinally and in height, the lower face of which carries the rib able to slide in one of the rails 13.

The second locking means (not visible in the Figures) can then include notches (not represented) movably mounted on the foot 111 and able to engage with the corresponding notches in the rail 13.

The second maneuvering means here comprises a lever 116 accessible to the seat occupant and allowing, when the seat occupant wishes to move forward or backward, to move the notches of the feet 111 away from those of the rail 13 to release the sliding mobility of the support 110. At rest (in the activated state), the notches cooperate with each other and are maintained in this position, for example by elastic return means. These notches then move away from each other only when the lever is operated by the occupant (in the deactivated state).

Here, as shown in FIG. 3, this lever 116 forms a rod the central part of which is bent in a U-form to be accessible from the front of the seat 100, and the two coaxial ends of which are housed in the two feet 111, forming a yoke.

This lever 116 could be used to extract the support 110 from the rails 13. It could be provided that the rear ends of the rails are all open so that, by sliding the support 110 toward the rear, it is possible to extract it from these rails 13.

However, preferably, a mechanism is provided to allow the support 110 to be extracted from the rails 13 regardless of the position of the support along these rails. Here, this mechanism is controlled by a strap 115 that can be pulled to retract the notches of the feet 111 to extract them from the rails 13.

This mechanism is described in more detail in document FR2950300.

The two feet 111 are, for example, formed of metal, and are here produced by a stamping operation of a steel sheet.

The platform 112, which connects the two feet 111, is also formed of metal.

It presents, in the example illustrated in FIG. 3, the form of a Swiss cross, with four notches at its four corners.

It preferably extends horizontally and/or parallel to the floor 12.

The anchoring means 114 carried by this platform 112 so that the chair 120 can be fixed to it preferably includes at least three anchoring points. Here, it even more preferably includes four.

Here, each anchoring point is formed by a section 114A of a rod on which the first locking means 129 of the chair can latch and lock.

Each section 114A of the rod preferably presents an L-form, to extend from one side to the other of the notch in which it is located.

In practice, it can be provided that the four sections 114A of the rod are formed from a single piece (called “rod”) folded according to a rectangular contour, and that the platform 112 is clipped over this single rod. Alternatively, the four sections 114A of the rod could form distinct pieces and be welded to the edges of the notches of the platform.

Here, this single rod is formed by a rigid rod, preferably metal (here steel). This rod, for example, presents a circular section.

The form of the rod is such that the platform 112 presents at least one vertical plane of symmetry. Here, it presents two vertical and perpendicular planes of symmetry to each other. In this way, the first locking means 129 of the chair 120 can be fixed to the rod in four positions: facing the road, back to the road, turned to the left, or turned to the right.

The first locking means 129 that allow the chair 120 to be fixed to this rod can then be described in more detail.

They are here located protruding from the lower faces of the flanks of the supporting structure 123 of the chair 120.

They could include four identical systems. But here, and preferably, they include two front latches 140 and two rear locks 130 able to be locked respectively on the four sections 114A of the rod.

These latches and locks present different forms.

As shown in FIG. 4, the locks 130 each include a fixed base 131 in the form of a clamp, which defines a notch 133 for the rod.

This notch 133 is open toward the bottom. Thus, the locking of the chair 120 on the support 110 is done by vertically bringing the locks 130 onto the corresponding sections 114A of the rod.

Each lock 130 also includes a bolt 132 mounted, pivoting, on the fixed base 131 around a transverse axis, between an activated position in which it blocks the rod at the bottom of the notch and a deactivated position in which it releases the rod, here by retracting to the inside of the fixed base.

An elastic return means allows to retain the bolt 132 in the activated position. The maneuvering means 134 accessible to the user to bring the bolt 132 to the deactivated position here presents the form of a lever, preferably accessible from the rear of the seat or the side of the seat.

It should be noted that the mechanism of the bolt 132 is such that it is not necessary to use this lever to lock the lock 130 on the corresponding section 114A of the rod.

Each latch 140 presents a similar form, with a fixed base 141 that delimits a notch 143 and a bolt 142 that pivots relative to the fixed base 141. However, the notch 143 opens toward the front. Thus, the locking of the chair 120 on the support 110 is done by tilting the chair toward the front and then bringing it horizontally. In addition, the maneuvering means 144 of the bolt 142 here presents in the form of a lever 144 that is accessible from under the chair 120. This lever 144 is designed in such a way that when the latch is brought onto the corresponding section 114A of the rod, the lever comes to rest against the platform 112, which allows the latch to lock onto the rod.

Thus, as shown in FIG. 2, to remove the chair 120 from its support 110, it is necessary to fold the backrest 121 onto the seat 122, maneuver the bolts 132 of the rear locks 130 in order to tilt the chair 120 toward the front, and possibly maneuver the bolts 142 of the latches 140 to completely remove the chair 120 from its support 110 (this last maneuver can be performed automatically, for ease, if the bolt 142 is elastically returned to the deactivated position).

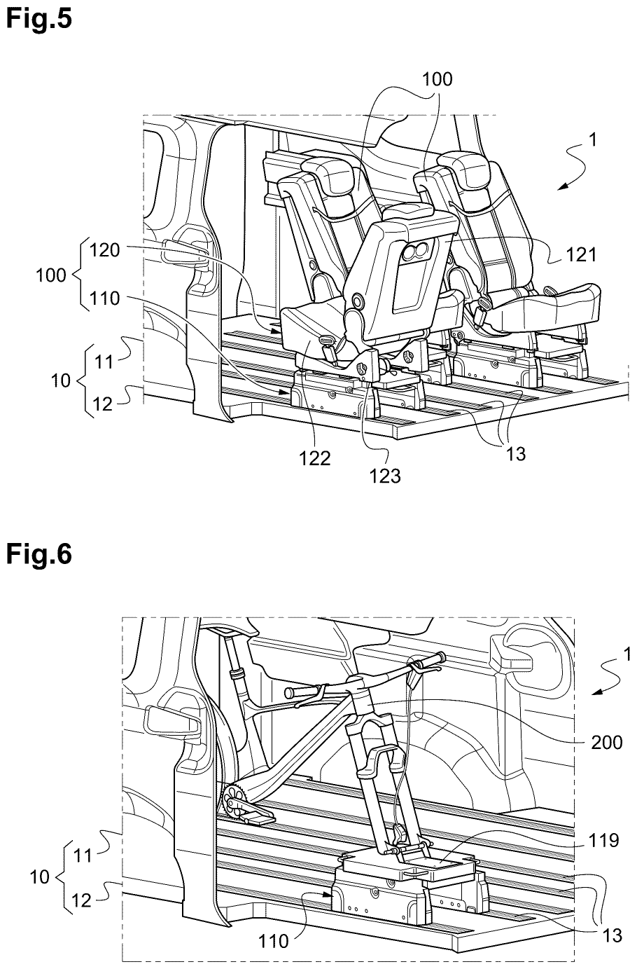

As shown in FIG. 5, it is then possible to turn the chair 120 to fix it head-to-tail on its support 110.

It is also possible to place it away from its support, on the floor, or to remove it from the vehicle.

The support 110 can then also be extracted from the rails 13 or remain in place.

In this last case, it can be used to support equipment distinct from the components of the motor vehicle 1. It can thus be used to secure any object in the cabin (for example using straps).

Preferably, the support can be equipped with fixing means 119 able to secure leisure and/or sports equipment such as, for example, a bike 200 (FIG. 6) or a surfboard. The fixing means 119 can be installed as needed on the support 110 or can be provided natively on it.

In the example represented in FIG. 6, the fixing means is screwed onto the platform 112. Alternatively, it could be provided to be clipped onto the rod of the support 110.

It should also be noted that the chair represented in the figures can be removed from its support 110 and be replaced by a baby or child seat, as long as the latter includes means of fixing it to the rod of the support.

The present disclosure is not limited to the described and represented embodiment, but the skilled person will know how to make any alternatives in accordance with the present disclosure.

Typically, the support 110 could include the first locking means 129 and the first maneuvering means 134, 144, in which case it would be the chair 120 that includes the anchoring means 114.

What is claimed is:

1. A vehicle seat comprising:
a chair that comprises a seat and a backrest; and
a support configured to be mounted on a floor of a motor vehicle and on which the chair is mounted, wherein one from the support and the chair comprises an anchoring means, and the other of the support and the chair comprises:
a first locking means configured to lock onto said anchoring means to lock the chair onto the support; and
a first maneuvering means configured to deactivate the first locking means to release the chair from the support,
wherein the chair comprises a supporting structure on which the seat and the backrest are mounted, the supporting structure comprising the first locking means and the first maneuvering means or the anchoring means.

2. The vehicle seat according to claim 1, wherein the support comprises:
a second locking means configured to lock the support to the floor; and
a second manually maneuverable maneuvering means configured to deactivate the second locking means to release at least one mobility of the support relative to the floor.

3. The vehicle seat according to claim 2, wherein, the floor integrating parallel rails, the second maneuvering means are configured to release a sliding mobility of the support in said parallel rails.

4. The vehicle seat according to claim 1, wherein the anchoring means comprises, at least three anchoring points, a rod on which the first locking means is configured to be locked.

5. The vehicle seat according to claim 1, wherein the first locking means comprises a fixed base that defines a notch, and a bolt that is movably mounted relative to the fixed base between an activated position that is able to block a rod at the bottom of the notch and a deactivated position that releases the rod.

6. The vehicle seat according to claim 1, wherein the first locking means comprises two latches and two locks configured to be locked respectively on four sections of a rod.

7. The vehicle seat according to claim 1, wherein the chair is configured to be mounted on the support with two distinct orientations.

8. The vehicle seat according to claim 1, wherein the support comprises a fixing means configured to block an equipment distinct from the motor vehicle, preferably leisure and/or sports equipment such as a bike or a surfboard.

9. The vehicle seat according to claim 8, wherein the equipment is a leisure equipment or a sport equipment.

10. The vehicle seat according to claim 8, wherein the equipment is a bike or a surfboard.

11. A motor vehicle comprising a chassis that comprises a floor, comprising at least one seat in accordance with claim 1, mounted on the floor.
